(19) United States
(12) Patent Application Publication
(10) Pub. No.: US 2011/0031422 A1
(43) Pub. Date: Feb. 10, 2011

(54) VALVE-CONTROLLED POSITIVE-DISPLACEMENT MACHINE

(76) Inventors: Alejandro Lopez Pamplona, Horb (DE); Bjoern Beuter, Hirrlingen (DE)

Correspondence Address: MICHAEL J. STRIKER, 103 EAST NECK ROAD, HUNTINGTON, NY, 11743, US

(21) Appl. No.: 12/849,275

(22) Filed: Aug. 3, 2010

(30) Foreign Application Priority Data
Aug. 4, 2009 (DE) 10 2009 036 021.2

(51) Int. Cl. F16K 31/12; F16K 31/02

(52) U.S. Cl. 251/12; 251/129.01

(57) ABSTRACT

In a valve-controlled hydrostatic positive-displacement machine and a method for its control, the positive-displacement machine having a plurality of cylinder-piston units which are activated or deactivated via electrically or electro-hydraulically actuated low-pressure valves and via high-pressure valves for setting a delivery or absorption volume flow of the positive-displacement machine, if the volume flow is essentially unchanged, the activation and deactivation of the cylinder-piston units is effected in accordance with one of a plurality of activation patterns valid for the particular volume flow.

### BACKGROUND OF THE INVENTION

The invention relates to a method for controlling a valve-controlled hydrostatic positive-displacement machine and to a valve-controlled hydrostatic positive-displacement machine.

In conventional positive-displacement machines, which can be embodied as radial or axial piston machines, for instance, the control of the inflow and outflow of the individual cylinder-piston units is done mechanically. In the case of an axial piston pump, for example, two pressure crescents are used, by way of which the connections with the high-pressure side and the low-pressure side open during a certain range of the orbit and thus during a certain stroke segment of the cylinder-piston units.

In radial piston pumps, one high-pressure valve and one low-pressure valve per cylinder-piston unit are provided, and the valves are mechanically controlled. The high-pressure valve of each unit for instance always opens if a certain built-up pressure in the applicable cylinder of the unit is exceeded, so that the pressure fluid with elevated pressure can flow off to the high-pressure side of the pump.

A disadvantage of such hydrostatic positive-displacement machines is that all the cylinder-piston units are always active.

International Patent Disclosure WO 2008/012558 A2 discloses valve-controlled positive-displacement machines, known as digital displacement units (DDUs), in which each cylinder-piston unit is assigned one electrically actuated low-pressure valve and one electrically actuated high-pressure valve.

Thus the units are triggerable via the two valves separately in the pump mode, motor mode and a so-called idle mode. By means of the idle mode, individual units can be deactivated or in other words switched to be forceless by suitable actuation of both valves. It is thus possible to reduce the volume flow or the rotary speed of the positive-displacement machines.

A disadvantage of such valve-controlled positive-displacement machines (DDUs) is the pressure surges (pulsation), which result from the alternation of active and inactive cylinder-piston units. This pulsation, for instance in the case of a pump, can excite a hydraulic system connected to it to unwanted vibration, especially if the pulsation matches a resonant frequency of the system.

### SUMMARY OF THE INVENTION

By comparison, it is the object of the invention to create a valve-controlled hydrostatic positive-displacement machine (DDU) and a method for controlling it, in which the excitation to vibration of a connected hydraulic system (in the case of a pump) or a connected power takeoff shaft (in the case of a motor) by the pulsation of the positive-displacement machine can be reduced.

In the method of the invention for controlling a valve-controlled hydrostatic positive-displacement machine, having a plurality of cylinder-piston units which are activated or deactivated via electrically or electrohydraulically actuated low-pressure valves and via high-pressure valves for setting a delivery or absorption volume flow of the positive-displacement machine, if the volume flow is essentially unchanged the activation and deactivation of the cylinder-piston units is effected in accordance with one of a plurality of equalizing activation patterns that valid for the particular volume flow. As a result, the pulsation in the operating state with deactivated units can be varied or reduced, and the excitation to vibration of a connected hydraulic system (in the case of a pump) or of a connected power takeoff shaft (in the case of a motor) can be reduced.

In one preferred exemplary embodiment of the method of the invention, the activation or deactivation of the cylinder-piston units is effected in accordance with an activation pattern which applies to one revolution of a shaft of the positive-displacement machine, so that during the revolution, at least one cylinder-piston unit is activated, and one other cylinder-piston unit is deactivated.

In another preferred exemplary embodiment of the method of the invention, the activation or deactivation of the cylinder-piston units is effected in accordance with an activation pattern which applies to more than one revolution of a shaft of the positive-displacement machine, and in which pattern, at least one cylinder-piston unit is activated upon one revolution of the shaft and deactivated upon another revolution of the shaft. A finer graduation of the volume flow of the positive-displacement machine than the number of cylinders in principle allows is thus possible. For instance, in a machine with six cylinder-piston units, a volume flow of 25% of the stroke volume of all the cylinders is also possible, if the corresponding activation pattern extends over two revolutions of the shaft. To that end, in the first revolution one unit (17%) is activated, and in the ensuing revolution, two units (33%) are activated.

In an especially preferred refinement of the method of the invention, the cylinder-piston units are activated or deactivated via electrically or electrohydraulically actuated high-pressure valves for setting a delivery or absorption volume flow of the positive-displacement machine. Thus operation of the positive-displacement machine as a motor is also possible.

It is preferred if the activation or deactivation of the cylinder-piston units is effected in accordance with a mixed-mode activation pattern, in which at least one cylinder-piston unit is activated in a pump mode, and at least one other cylinder-piston unit is activated in a motor mode. The volume flow of the positive-displacement machine can thus be varied. Hence further possible activation patterns are created for a predetermined volume flow, so that the selection options of the activation pattern are increased, and the excitation to vibration can be further reduced.

For instance, the activation of the at least one cylinder-piston unit in the pump mode is effected during one revolution of the shaft, and the activation of the at least one cylinder-piston unit in the motor mode is effected during another revolution of the shaft. Hence further possible activation patterns are created for a predetermined volume flow, so that the selection options of the activation pattern are increased, and the excitation to vibration can be further reduced.

In a preferred refinement of the method of the invention, the activation or deactivation of the cylinder-piston units is effected in accordance with an equalizing activation pattern, in which during one revolution of the shaft the cylinder-piston units of a first group, having a predetermined number of cylinder-piston units, are activated, and during a different revolution of the shaft, a second group with other cylinder-piston units is activated. Thus the wear of the positive-displacement machine is distributed uniformly to the units, and the service life of the positive-displacement machine is thus prolonged.

Depending on the design, pulsation of a connected hydraulic system (in the case of a pump) or vibration of a power takeoff shaft (in the case of a motor) can be calculated offline, and the activation pattern can be selected accordingly. Sensors for ascertaining the pulsation or the vibration are thus eliminated. This variant is advantageous for instance in relatively large-scale mass production of the positive-displacement machine and optionally of the hydraulic system.

Alternatively, the pulsation of the connected hydraulic system or the vibration of a power takeoff shaft is ascertained online by sensors, and the optimal activation pattern is selected online accordingly. As a result, better compensation is possible for variations in production of the positive-displacement machine and possibly of the hydraulic system, and in the individual case, better suppression of pulsation or vibration is possible. This variant is advantageous for instance in relatively smaller-scale mass production.

The valve-controlled hydrostatic positive-displacement machine of the invention, having a plurality of cylinder-piston units which are activatable or deactivatable via electrically or electrohydraulically actuated low-pressure valves and via high-pressure valves for setting a delivery or absorption volume flow of the positive-displacement machine, has various activation patterns, according to which the cylinder-piston units are activatable or deactivatable when the average volume flow of the positive-displacement machine is unchanged. As a result, in operating states with deactivated units, the pulsation can be varied or reduced, and the excitation to vibration of a connected hydraulic system (in the case of a pump) or of a connected power takeoff shaft (in the case of a motor) is reduced.

A preferred exemplary embodiment relates to a radial piston machine having a lifting curve extending around an axis of rotation; the lifting curve is located on the inside of a lifting ring or on the outside of an eccentric element. The pistons of each of the cylinder-piston units are braced on the lifting curve, and a plurality of cam portions are located on the lifting curve. As a result, the number of work strokes of each piston during one revolution of the lifting curve is simplified (for instance, with two cam portions, doubled from one work stroke to two work strokes). As a result, the volume flow of the positive-displacement machine is also multiplied in a corresponding way.

It is especially preferred if at least two cam portions are located on the lifting curve in pairs opposite one another relative to the axis of rotation. As a result, the forces of pistons likewise opposite one another in pairs and activated simultaneously can be exerted on the lifting curve or on the shaft connected to it; these forces are oriented opposite one another and thus compensate for one another.

In another preferred exemplary embodiment, the positive-displacement machine, besides a primary disk, also has one or more secondary disks, which are located spaced apart from one another along the axis of rotation. Each disk has a plurality of cylinder-piston units and one lifting curve, and the cylinders of the secondary disk or disks can be connected to the respective cylinders of the primary disk. Thus the volume flow of the positive-displacement machine can be increased.

It is especially preferred if one cam portion each of the lifting curve of the primary disk is located opposite, relative to the axis of rotation, a cam portion of the lifting curve of one or more of the secondary disks. As a result, the forces of pistons likewise opposite one another in pairs and activated simultaneously, forces that are oriented opposite one another and thus compensate for one another, can be exerted on the two lifting curves or on the shaft connected to them.

An especially preferred refinement of the positive-displacement machine of the invention can be operated as a pump and/or as a motor, and each cylinder-piston unit is assigned one electrically or electrohydraulically actuated high-pressure valve for setting a absorption volume flow.

In the usual variant of the positive-displacement machine that according to the invention is controllable via valves, each cylinder-piston unit is assigned precisely one electrically or electrohydraulically actuated low-pressure valve and precisely one passive or mechanical or electrically or electrohydraulically high-pressure valve.

### BRIEF DESCRIPTION OF THE DRAWINGS

An exemplary embodiment of the invention will be described in detail below in conjunction with the drawings.

FIG. 1 shows a sectional view of one exemplary embodiment of a valve-controlled radial piston pump according to the invention;

FIG. 2a is a volume flow graph of the valve-controlled radial piston pump of the invention, in accordance with a first activation pattern;

FIG. 2b is a frequency graph of the valve-controlled radial piston pump of the invention, in accordance with the first activation pattern;

FIG. 3a is a volume flow graph of the valve-controlled radial piston pump of the invention, in accordance with a second activation pattern; and

FIG. 3b is a frequency graph of the valve-controlled radial piston pump of the invention, in accordance with the second activation pattern.

### DETAILED DESCRIPTION OF THE PREFERRED EMBODIMENTS

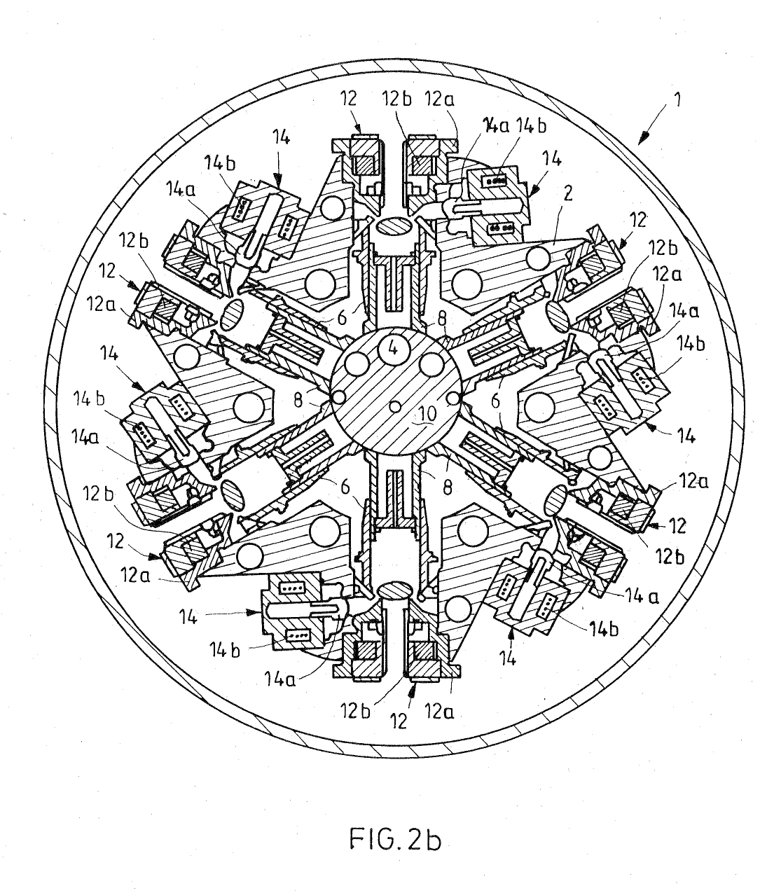

FIG. 1 shows one exemplary embodiment of a valve-controlled radial piston pump (Digital Displacement Unit) according to the invention in a sectional view. It has a housing 1, in which a stationary cylinder body 2 is received. Relative to an axis of rotation 4, six radial recesses are located in the cylinder body, with one cylinder-piston unit located in each recess. The six cylinder-piston units likewise extend approximately radially away from the axis of rotation 4. The bushlike cylinders 6, on their radially outer end portions, are secured pivotably to the cylinder body 2, and the pistons 8 are braced with their radially inner end portions on an eccentric element 10, or on its outer jacket face. The eccentric element 10 is supported rotatably about the axis of rotation 4 and is connected to a drive shaft (not shown) of the radial piston pump.

Each cylinder-piston unit 6, 8 is connected to a low-pressure connection (not shown) via a low-pressure valve 12 and to a high-pressure connection (also not shown) of the radial piston pump via a high-pressure valve 14. The six low-pressure valves 12 and the six high-pressure valves 14 are embodied as seat valves, and their valve bodies 12a, 14a are each actuated via a respective electric lifting magnet 12b, 14b. Thus the radial piston pump is embodied as a Digital Displacement Unit (DDU) in which each of the six cylinders 6 can be controlled independently of the other cylinders 6, via one low-pressure valve 12 and one high-pressure valve 14.

Upon a revolution of the eccentric element 10, each piston 8 in the associated cylinder 6 executes a working stroke, which comprises a positive-displacement stroke subjected to force and a reverse stroke. In the position of the eccentric element shown in FIG. 1, the piston 8, for instance of the cylinder-piston unit 8, 6 located at the top in FIG. 1, is shown at its top dead center, after the execution of the positive-displacement stroke, after which the pressure fluid has flowed out of this cylinder-piston unit 6, 8 via the high-pressure valve 14.

Instead of the above-described activation of the cylinder-piston units 6, 8 via the valves 12, 14 in the pump mode, individual cylinder-piston units 6, 8 can also be deactivated by the so-called idle mode during the positive-displacement stroke of their piston 8. To that end, during the positive-displacement stroke of the piston 8, instead of the high-pressure valve 14 the low-pressure valve 12 is opened, so that the corresponding pressure fluid can flow out, without counterpressure, back to the low-pressure or intake side of the radial piston pump. In this way, three of the six cylinder-piston units 6, 8 shown, for instance, can be deactivated during one revolution of the eccentric element 10, so that the delivery volume of the radial piston pump is halved.

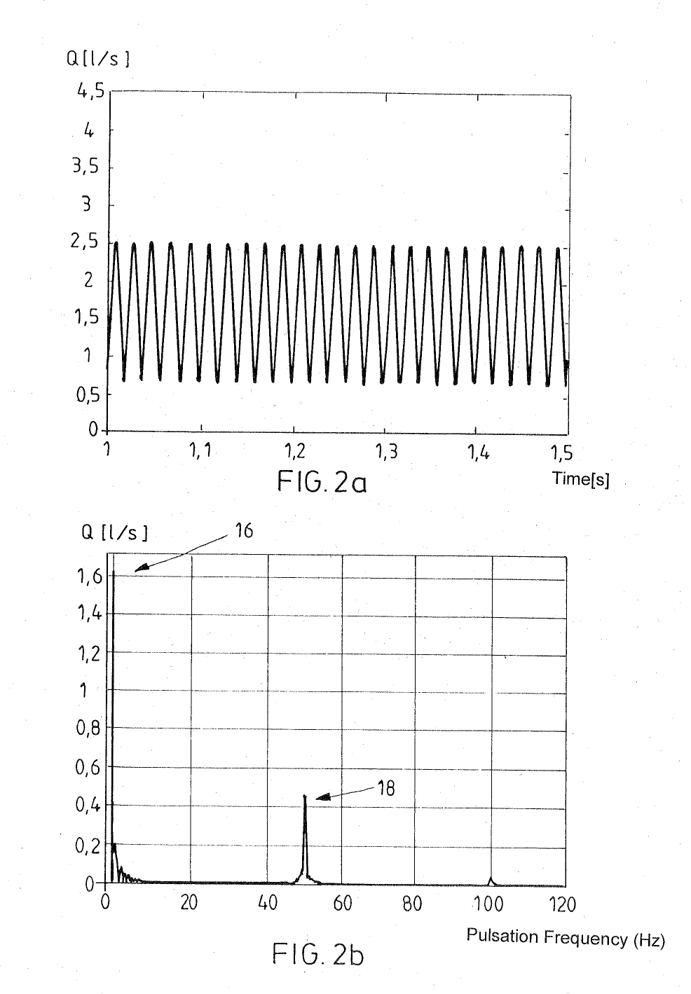

FIG. 2a shows a volume flow graph of the valve-controlled radial piston pump of the invention in accordance with a first activation pattern of its cylinder-piston units 6, 8. The radial piston pump has two disks, each with six cylinder-piston units 6, 8 and a 30° offset between the disks. Each cylinder-piston unit 6, 8 has an area of 16 cm³ (adding up to 192 cm³ in all).

This activation pattern provides that per revolution of the drive shaft and of the eccentric element 10 (see FIG. 1), the first cylinder-piston unit 6, 8 is activated, whereupon two successive cylinder-piston units 6, 8 are switched to be inactive. After that, the fourth cylinder-piston unit 6, 8 is switched to be active again, and the two last cylinder-piston units 6, 8 are deactivated again. The result is a “1 and 4 out of 6” activation pattern. In this way, two spaced-apart units of the total of six units 6, 8 are activated, as a result of which, per revolution, the radial piston pump positively displaces one-third of the maximum volume.

The graph in FIG. 2a shows the volume flow or delivery flow Q (in 1/sec) of the radial piston pump over time in accordance with the first activation pattern. The radial piston pump runs at 1500 revolutions per minute. The result is a pulsation in the delivery flow Q as shown.

FIG. 2b shows a frequency graph of the valve-controlled radial piston pump of the invention upon an activation in accordance with the first activation pattern, in which per revolution, the first and the fourth of the total of six cylinder-piston units 6, 8 are activated. The delivery flow Q (in 1/sec) is plotted over the various possible pulsation frequencies (in Hertz).

Essentially, there are two peaks 16, 18, of which the first peak 16 at a pulsation frequency of 0 Hertz indicates the mean delivery flow of 1.6 I/sec and is not relevant in terms of vibration.

The peak 18 that is characteristic for the first activation pattern can be found at 50 Hertz and has a pulsation intensity of approximately 0.5 I/sec.

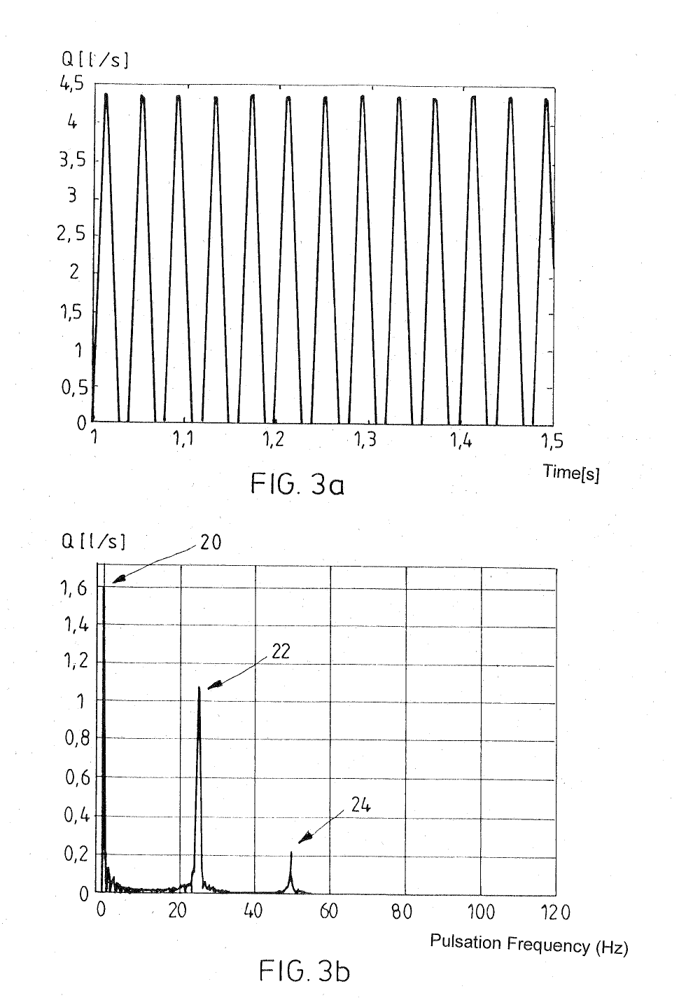

FIG. 3a shows a delivery current graph of the valve-controlled radial piston pump of the invention in accordance with a second activation pattern. Here the above-described radial piston pump (as in the case of the first activation pattern) is again operated with two active cylinders and four inactive cylinders. In a difference from the first activation pattern, in the second activation pattern two cylinder-piston units 6, 8 located side by side are activated, while the four units 6, 8 also located side by side are deactivated. Thus the second activation pattern is a pattern of “1 and 2 out of 6”.

The radial piston pump operated in this way has the volume flow or delivery flow Q (I/sec) over time (s) shown in FIG. 3a. The delivery flow has markedly higher peak values than with the first activation pattern (compare FIG. 2a); between the individual pressure fluid surges, the delivery quantity drops to 0 I/sec. Since only one pressure fluid surge (generated by two units 6, 8 in common) per revolution occurs, the maximum values are farther apart from one another than in the first activation pattern (compare FIG. 2a).

FIG. 3b shows a frequency graph of the valve-controlled radial piston pump of the invention in accordance with second activation pattern. Once again, the volume flow or delivery flow Q (I/sec) is plotted over the various pulsation frequencies (Hz). The peak 20, which occurs at a pulsation frequency of 0 Hertz, indicates the mean delivery current of the radial piston pump upon activation in accordance with the second activation pattern. As expected, this corresponds to that of the first activation pattern (compare FIG. 2b).

A peak 22 at 25 Hertz and a peak 24 at 50 Hertz were also measured. Upon comparison of this frequency graph with that of the first activation pattern, an additional, comparatively high peak 22 occurs, while the peak at 50 Hertz is markedly reduced.

This comparison of two activation patterns (“1 and 4 out of 6” and “1 and 2 out of 6”) shows only a small selection of the manifold possibilities that result according to the invention from the variation of activation patterns. In the example selected here of a radial piston pump with six cylinder-piston units 6, 8 and a delivery flow of one-third the maximum delivery flow, a further activation pattern of “1 and 3 out of 6” also results, for instance. The activation pattern can also be extended over a plurality of revolutions of the drive shaft or of the eccentric element 10. For instance, upon a first revolution, one of six cylinders can be activated, and upon a second revolution, three of six cylinders can be activated. Thus many possible activation patterns result, from which the optimal activation pattern can be selected for the particular instance of use.

With respect to the two activation patterns described and shown in FIGS. 2b and 3b, the selection according to the invention of the optimal activation pattern will now be described below as an example.

If the hydraulic system supplied by the radial piston pump has a natural frequency in the range of 25 Hertz, for instance, then the first activation pattern of FIG. 2b is selected, since in that frequency range, no pulsation and hence no vibration excitation is brought about by the radial piston pump.

If the hydraulic system has a natural frequency in the range of 50 Hertz, the radial piston pump is operated in accordance with the second activation pattern, since with it, the vibration excitation by the radial piston pump is markedly reduced compared to the first activation pattern. This can be found by comparing the peak 18 of FIG. 2b with the peak 24 of FIG. 3b.

In the case of a radial piston motor, the selection of the optimal activation pattern is made in the same way, but instead of the connected hydraulic system, the power takeoff shaft of the motor is taken into account.

Besides the goal of minimized vibration excitation, still other goals can be pursued by the variation according to the invention of activation patterns. For instance, it is possible to generate the most uniform possible wear of the existing cylinder-piston combinations of the machine. This is achieved by way of regular “replacement” of the active units. For instance, in a machine with six units and a desired delivery flow of 50%, the following activation pattern can be selected: Upon a first revolution, the units 1, 3 and 5 are activated, and in the ensuing revolution, the units 2, 4 and 6 are activated. In a different activation pattern, upon each revolution during the first operating cycle (for instance, one day), the units 1, 3 and 5 are activated, while in an ensuing operating cycle, units 2, 4 and 6 are activated upon each revolution.

Furthermore, with the variation according to the invention of the activation patterns, the bending forces that act on the drive shaft or power takeoff shaft of the machine can also be reduced. According to the invention, the units of a machine which then instead of the eccentric element has a cam disk with cams opposite one another in pairs, are always activated opposite one another. Then the supporting forces, aimed at one another, of the pistons compensate for one another in pairs.

Moreover, the supporting forces of the pistons can also be compensated for in radial piston machines that have two disks, each with units arranged in a star pattern. Then each disk is constructed in accordance with the principle shown in FIG. 1 and has an eccentric element 10 with a cam. The two cams on the two disks are disposed opposite one another with respect to the axis of rotation 4 or shaft. In such a machine, once again compensation for the supporting force of one piston is possible with the supporting force of a piston belonging to the other disk and opposite it (with respect to the axis of rotation 4).

What is disclosed is a valve-controlled hydrostatic positive-displacement machine and a method for its control, the positive-displacement machine having a plurality of cylinder-piston units which are activated or deactivated via electrically or electrohydraulically actuated low-pressure valves and via high-pressure valves for setting a delivery or absorption volume flow of the positive-displacement machine. According to the invention, if the volume flow is essentially unchanged, the activation and deactivation of the cylinder-piston units is effected in accordance with one of a plurality of activation patterns valid for the particular volume flow.

It will be understood that each of the elements described above, or two or more together, may also find a useful application in other types of constructions differing from the types described above.

While the invention has been illustrated and described as embodied in a device having a torque-limiting unit, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

### LIST OF REFERENCE NUMERALS

1 Housing
2 Cylinder body
4 Axis of rotation
6 Cylinder
8 Piston
10 Eccentric element
12 Low-pressure valve
14 High-pressure valve
12a Valve body
14a Valve body
12b Lifting magnet
14b Lifting magnet
16 Peak
18 Peak
20 Peak
22 Peak
24 Peak

1. A method for controlling a valve-controlled hydrostatic positive-displacement machine having plurality of cylinder-piston units (6, 8), comprising the following steps:
activating or deactivating the cylinder-piston units (6, 8) via electrically or electrohydraulically actuated low-pressure valves (12) and via high-pressure valves (14) adapted to set a delivery or absorption volume flow of the positive-displacement machine, wherein in a substantially unchanged equalized volume flow of the positive-displacement machine; and
effecting the activation and deactivation of the cylinder-piston units (6, 8) according to a selected one of a plurality of activation patterns that are valid for a particular equalized volume flow.

2. The method for controlling a positive-displacement machine as recited in claim 1, wherein in accordance with an activation pattern that applies to one revolution of a shaft of the positive-displacement machine, at least one cylinder-piston unit (6, 8) is activated and another cylinder-piston unit (6, 8) is deactivated.

3. The method for controlling a positive-displacement machine as recited in claim 1, wherein in accordance with an activation pattern that applies to a plurality of revolutions of a shaft of the positive-displacement machine, at least one cylinder-piston unit (6, 8) is activated upon one revolution of the shaft and deactivated upon another revolution of the shaft.

4. The method for controlling a positive-displacement machine as recited in claim 1, wherein the cylinder-piston units (6, 8) are activated or deactivated via electrically or electrohydraulically actuated high-pressure valves (14) for setting a delivery or absorption volume flow of the positive-displacement machine.

5. The method for controlling a positive-displacement machine as recited in claim 4, further comprising the steps of activating at least one cylinder piston unit (6, 8) in a pump mode and activating at least one other cylinder-piston unit (6, 8) in a motor mode in a mixed-mode activation pattern.

6. The method for controlling a positive-displacement machine as recited in claim 5, wherein the activation of the at least one cylinder-piston unit (6, 8) in the pump mode is effected during one revolution of a shaft of the positive-displacement machine, while the activation of the at least one cylinder-piston unit (6, 8) in the motor mode is effected during another revolution of the shaft.

7. The method for controlling a positive-displacement machine as recited in claim 1, wherein in an equalizing activation pattern, upon a revolution of a shaft of the positive-displacement machine, the cylinder-piston units (8) of a first group, having a predetermined number of cylinder-piston units (6, 8), are activated, and upon a different revolution of the shaft, a second group having other cylinder-piston units is activated.

8. The method for controlling a positive-displacement machine as recited in claim 1, further comprising the steps of calculating offline a pulsation of a connected hydraulic system or a vibration of a power takeoff shaft and selecting the activation pattern accordingly.

9. The method for controlling a positive-displacement machine as recited in claim 1, further comprising the steps of ascertaining online a pulsation of a connected hydraulic system or a vibration of a power takeoff shaft by sensors, and selecting online the activation pattern accordingly.

10. A valve-controlled hydrostatic positive-displacement machine, comprising:
a plurality of cylinder-piston units (6, 8) that are configured to be activatable or deactivatable via electrically or electrohydraulically actuated low-pressure valves (12) and via high-pressure valves (14) for setting a delivery or absorption volume flow of the positive-displacement machine;
a plurality of activation patterns, wherein according to said activation patterns, the cylinder-piston units (6, 8) are activatable or deactivatable in an essentially unchanged volume flow of the positive-displacement machine.

11. The positive-displacement machine as recited in claim 10, wherein said machine is a radial piston machine with a lifting curve extending completely around an axis of rotation, wherein the lifting curve is formed on an inside of a lifting ring or on the outside of an eccentric element, wherein the pistons of each cylinder-piston unit are braced on the lifting curve, and wherein a plurality of cam portions are located on the lifting curve.

12. The positive-displacement machine as recited in claim 11, wherein at least two cam portions are located on the lifting curve, and are located in pairs opposite one another relative to the axis of rotation.

13. The positive-displacement machine as recited in claim 11, further comprising a primary disk and at least one secondary disk located spaced apart from one another along the axis of rotation, wherein each disk has a plurality of cylinder-piston units and one lifting curve, and wherein the cylinders of the secondary disks are connectable to respective cylinders of the primary disk.

14. The positive-displacement machine as recited in claim 13, wherein one cam portion each of the lifting curve of the primary disk is located opposite a cam portion of the lifting curve of the at least one secondary disk, relative to the axis of rotation.

15. The positive-displacement machine as recited in claim 10, wherein said machine is configured to be operable as a pump and/or as a motor, wherein each cylinder-piston unit (6, 8) is assigned one electrically or electro-hydraulically actuated high-pressure valve (14) for setting an absorption volume flow.

16. The positive-displacement machine as recited in claim 10, wherein each cylinder-piston unit (6, 8) is assigned only one electrically or electro-hydraulically actuated low-pressure valve (12) and only one passive or electrically or electro-hydraulically actuated high-pressure valve (14).
